(19) United States
(12) Patent Application Publication
(10) Pub. No.: US 2014/0328137 A1
(43) Pub. Date: Nov. 6, 2014

(54) MIXING METHODS AND SYSTEMS FOR FLUIDS

(71) Applicants: M-I L.L.C., Houston, TX (US); M-I DRILLING FLUIDS U.K. LIMITED, Aberdeen (GB)

(72) Inventors: Colin Lauder, Richmond, TX (US); Daniel Knapper, London (GB); Gordon MacMillan Logan, Aberdeen (GB)

(21) Appl. No.: 14/358,601

(22) PCT Filed: Nov. 16, 2012
(86) PCT No.: PCT/US12/65440

§ 371 Date: May 15, 2014

Related U.S. Application Data
(60) Provisional application No. 61/561,454, filed on Nov. 18, 2011.

(51) Int. Cl. B01F 15/04; E21B 21/06

(52) U.S. Cl. CPC B01F 15/0441; E21B 21/062
USPC 366/152.2

(57) ABSTRACT

A system for mixing fluids includes at least two pressurized containers, a batching hopper in fluid communication with at least one of the at least two pressurized containers, a mixer in fluid communication with the batching hopper, and a fluid line in fluid communication with the mixer. An automated method of mixing fluids includes measuring a property of a fluid in a rig fluid system, transferring contents from a rig storage container to a batching hopper, transferring the contents from the batching hopper to a mixer, determining an amount of contents to add to a flow of the fluid in the rig fluid system based on the measured property, and mixing the determined amount of contents in the mixer with the flow of fluid from the rig fluid system.

### BACKGROUND

In the drilling of wells, a drill bit is used to dig many thousands of feet into the earth's crust. Oil rigs typically employ a derrick that extends above the well drilling platform. The derrick supports joint after joint of drill pipe connected end-to-end during the drilling operation. As the drill bit is pushed further into the earth, additional pipe joints are added to the ever lengthening “string” or “drill string”. Therefore, the drill string typically includes a plurality of joints of pipe.

Fluid “drilling mud” is pumped from the well drilling platform, through the drill string, and to a drill bit supported at the lower or distal end of the drill string. The drilling mud lubricates the drill bit and carries away well cuttings generated by the drill bit as it digs deeper. The cuttings are carried in a return flow stream of drilling mud through the well annulus and back to the well drilling platform at the earth's surface. When the drilling mud reaches the platform, it is contaminated with small pieces of shale and rock that are known in the industry as well cuttings or drill cuttings. Once the drill cuttings, drilling mud, and other waste reach the platform, a “shale shaker” is typically used to remove the drilling mud from the drill cuttings so that the drilling mud may be reused. The remaining drill cuttings, waste, and residual drilling mud are then transferred to a holding trough for disposal. In some situations, for example with specific types of drilling mud, the drilling mud may not be reused and it must also be disposed. Typically, the non-recycled drilling mud is disposed of separate from the drill cuttings and other waste by transporting the drilling mud via a container to a disposal site.

Drilling fluid is mixed at the drilling location and may include various additives. The additives may be transferred to the drilling locations in bags, the bags opened, and then the contents of the bags added to a base fluid, such as water, oil, or synthetic base fluids.

### SUMMARY OF THE DISCLOSURE

In one aspect, embodiments disclosed herein relate to a system for mixing fluids, the system including at least two pressurized containers, a batching hopper in fluid communication with at least one of the at least two pressurized containers, a mixer in fluid communication with the batching hopper, and a fluid line in fluid communication with the mixer.

In another aspect, embodiments disclosed herein relate to a method of mixing fluids, the method including providing a flow of contents from at least two pressurized containers to a batching hopper, determining a mass of contents transferred from the at least two pressurized containers to the batching hopper, measuring a property of a fluid flowing through a fluid line, wherein the fluid line is in fluid communication with the batching hopper, and transferring a volume of the contents from the batching hopper to a mixer, wherein the volume transferred is adjusted based on the measured property of the fluid.

In yet another aspect, embodiments disclosed herein relate to a system for mixing fluids, the system including a first pressurized container disposed at a first location at a drilling site, a second pressurized container disposed at a second location at the drilling site, a batching hopper in fluid communication with at least one of the first and second pressurized containers, an auger disposed at a distal end of the batching hopper and in fluid communication with the batching hopper, and a mixer in fluid communication with the auger.

In yet another aspect, embodiments disclosed herein relate to an automated method of mixing fluids, the method including measuring a property of a fluid in a rig fluid system, transferring contents from a rig storage container to a batching hopper, transferring the contents from the batching hopper to a mixer, determining an amount of contents to add to a flow of the fluid in the rig fluid system based on the measured property, and mixing the determined amount of contents in the mixer with the flow of fluid from the rig fluid system.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

FIG. 1 is a schematic representation of a mixing system according to embodiments of the present disclosure.

FIG. 2 is a schematic representation of a mixing system according to embodiments of the present disclosure.

FIG. 3 is a schematic representation of a mixing system according to embodiments of the present disclosure.

FIGS. 4-6 are various views of pressurized vessels according to embodiments of the present application.

FIGS. 7A, 7B, and 8 are various views of mixers according to embodiments of the present application.

FIGS. 9 and 10 are flowchart representations of methods for mixing fluids according to embodiments of the present application.

FIG. 11 is a schematic representation of a computer system according to embodiments of the present disclosure.

### DETAILED DESCRIPTION

In one aspect, embodiments disclosed herein relate generally to systems and methods for mixing fluids. More specifically, embodiments disclosed herein relate to system and methods for mixing fluids at a drilling location. More specifically still, embodiments disclosed herein relate to system and methods for mixing drilling and cementing fluids at a drilling location.

At a drilling location, during both drilling and subsequent wellbore operations, such as cementing, work over, cuttings reinjection, and the like, various fluids are mixed. The composition of the fluids may vary depending on the type of operation that is performed, and as such, various fluid additives, or fluid contents, may be added to a base fluid prior to the fluid being used. Examples of fluid additives may include, for example, barite, bentonite, calcium carbonate, and other additives that may be used to adjust one or more properties of the fluid. Examples of measured fluid properties that may be adjusted through the use of fluid additives include viscosity/rheology, pH, density, gel strength, API fluid loss, and electrical stability. Examples of base fluids include water-based fluids, oil-based fluids, and synthetic-based fluids.

Fluid additive transference to and at the well site may often result in the transferring of multiple heavy bags of additives, which are added to a mixer, in order to make a particular fluid. Such operations often use manual handling methods which pose health and safety issues for the operators. Alternatively, mechanical bag cutting machines may be employed to speed the process, but which have considerable cost and space requirements.

Mixing Systems

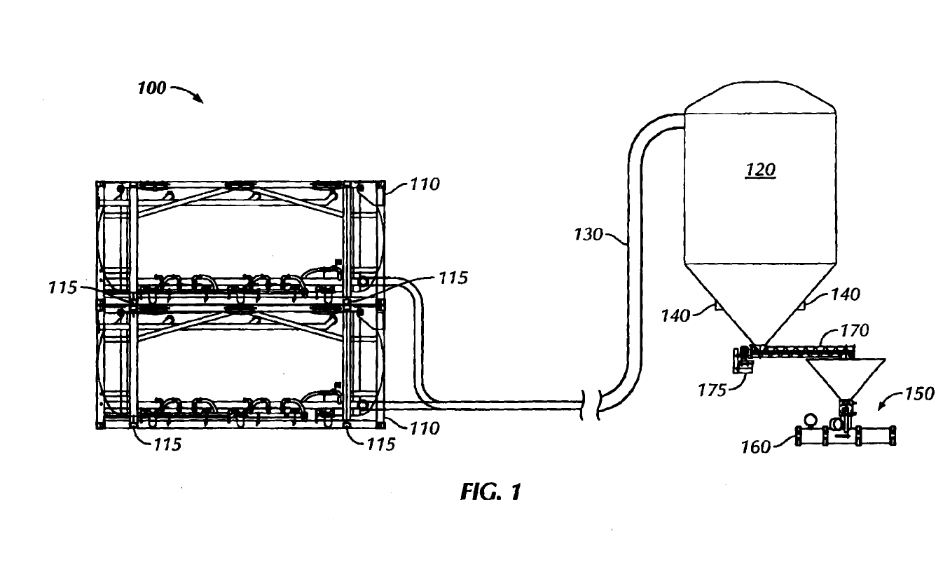

Referring to FIG. 1, a schematic representation of a mixing system 100 according to embodiments of the present disclosure is shown. In this embodiment, a plurality of pressurized containers 110 is disposed at a drilling location. As illustrated, pressurized containers 110 are disposed on top of one another; however, in alternative embodiments, pressurized containers 110 may be disposed next to one another, in a side-by-side configuration or disposed at different locations at the drilling site. The operation of pressurized containers 110 will be discussed in detail below. Generally, pressurized containers 110 are containers configured to hold fluid additive contents and promote the transfer of the contents through pneumatic transference. As such, pressurized container 110 may be fluidly connected to one or more air compressors (not shown). Those of ordinary skill in the art will appreciate that in certain embodiments pressurized containers 110 may be fluidly connected to air compressors that are a part of the rig infrastructure, while in other embodiments, additional air compressors may be used.

Pressurized containers 110 are fluidly connected to a batching hopper 120 through fluid conduits 130. Fluid conduits 130 may include various piping capable of allowing contents to be pneumatically transferred from pressurized containers 110 to batching hopper 120. Batching hopper 120 is a container that is configured to receive and hold a mass of contents. Depending on the requirements of the mixing operation, the volume of batching hopper may vary. For example, in certain embodiments, the volume of batching hopper 120 may be approximately 4.0 m³, while it other embodiments the volume may be about 1.5 m³ or 0.5 m³. Those of ordinary skill in the art will appreciate that the specific volume of batching hopper 120 may vary based on the volume of drilling fluid being mixed, as well as the volume of fluid additive contents that are added to the fluid. If small volumes of fluid are being mixed or relatively little additive is being added to the fluid, batching hopper 120 may be relatively smaller.

Batching hopper 120 is coupled to a mass measuring apparatus 140, in this embodiment, a plurality of load cells. The load cells are configured to calculate a mass of contents within batching hopper 120 at any given time interval. Thus, as contents are transferred from pressurized containers 110 to batching hopper 120, mass measuring apparatus 140 may calculate the mass of contents in batching hopper on a substantially continuous basis. In other embodiments, mass measuring apparatus 140 may only be used to take incremental mass measurements.

Mixing system 100 further includes a mixer 150 disposed below batching hopper 120. Mixer 150 may be any type of mixer that is capable of mixing a solid fluid additive to a fluid. In one embodiment, mixer 150 may include a shear mixer, static mixer, and/or dynamic mixer. In certain embodiments, high shear dynamic mixers, such as the in-line mixer illustrated here, may provide for efficient, aeration-free, self-pump mixing to further homogenize the dispersion of the fluid additive within a base fluid.

Mixer 150 receives a flow of base fluid from a fluid line 160. Mixer introduces the contents received from batching hopper 120 into the flow of fluid received from fluid line 160, and the resultant fluid enters the active fluid system (not shown) at the well site.

In certain embodiments, such as that illustrated in FIG. 1, an auger 170 may be disposed between batching hopper 120 and mixer 150. Auger 170 is disposed at a distal, lower end of batching hopper 120 and controls the speed contents from batching hopper 120 are transferred to mixer 150. Auger 170 may be controlled through a motor 175, which receives control signals from a human machine interface (“HMI”) (not shown).

The HMI, in addition to being operatively connected to auger 170 may also be operatively connected to mass measuring apparatus 140. Thus, the HMI may receive an updated mass of the contents in batching hopper 120 from mass measuring apparatus 140 and may be used to control the speed of auger 170, ₜhereby controlling the rate of contents transfer from batching hopper 120 into mixer 150.

In alternative embodiments, pressurized containers 110 may also have mass measuring apparatuses 115 disposed in operational contact therewith. In such an embodiment, the mass of contents removed from pressurized containers 110 may be determined and transmitted to the HMI. In such an embodiment, batching hopper 120 may also have mass measuring apparatuses 140, thereby allowing for redundancy in the mass transfer determination. Those of ordinary skill in the art will appreciate that in certain embodiments, the mass measurements from mass measuring apparatuses 140 and 115 may be transferred to a centralized control system (not shown) regardless of whether an HMI is used.

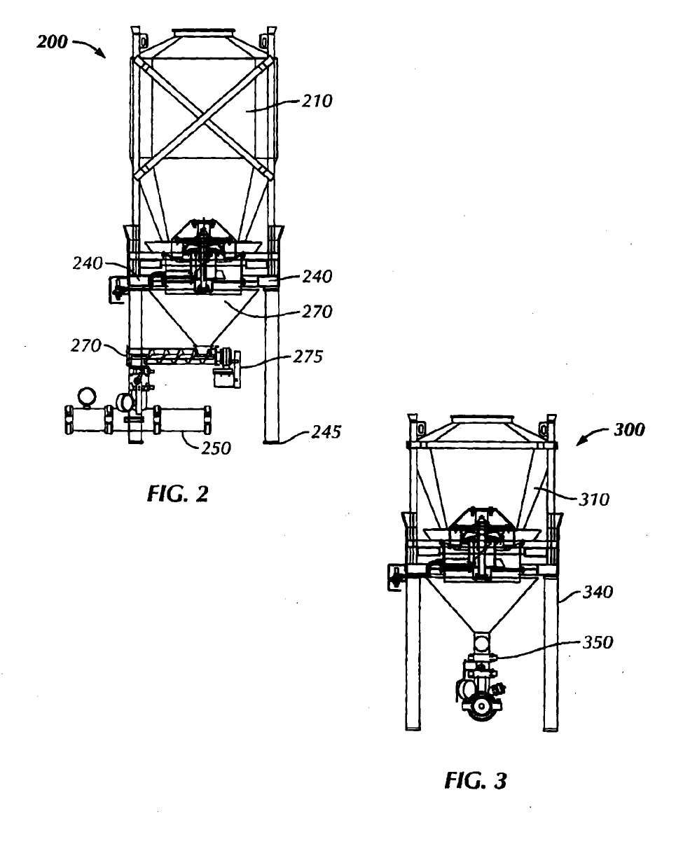

Referring to FIG. 2, a schematic representation of a mixing system 200 according to embodiments of the present disclosure is shown. In this embodiment, mixing system 200 is configured to receive a flow of contents from a rig storage container 210. As illustrated, rig storage container 210 is disposed above a batching hopper 220, and as such, contents in rig storage container 210 may be gravity fed into batching hopper 220 by, for example, opening a valve (not shown) disposed therebetween.

One or more mass measuring apparatuses 240 may be disposed between rig storage container 210 and batching hopper 220. Alternatively or in addition to mass measuring apparatuses 240, one or more mass measuring apparatuses 245 may be disposed below batching hopper 220. The mass of contents introduced into batching hopper 220, or into a mixer 250, may thereby be calculated.

As with mixing system 100, mixing system 200 includes mixer 250 in fluid communication with batching hopper 220. An auger 220 is disposed between batching hopper 220 and mixer 250. Batching hopper 270 includes a motor 275 that is configured to control the speed of auger 270. Auger 270 may be operatively connected to an HMI (not shown). HMI may also be operatively connected to one or more of mass measuring apparatuses 240 and 245. Thus, as with mixing system 100, the HMI may control the transference of contents from rig storage container 210 and batching hopper 220 into mixer 250.

Referring to FIG. 3, a schematic representation of a mixing system 300 according to embodiments of the present disclosure is shown. In this embodiment, mixing system 300 is configured to receive a flow of contents from a rig storage container 310. As illustrated, rig storage container 310 is disposed above a mixer 350, and as such, contents in rig storage container 310 may be gravity fed into mixer 350 by, for example, opening a valve (not shown) disposed therebetween. One or more mass measuring apparatuses 340 may be disposed between rig storage container 310 and mixer 350. The mass of contents introduced into a mixer 350, may thereby be calculated.

As with mixing systems 100 and 200, mixing system 300 includes mixer 350 in fluid communication with rig storage container 310. In this embodiment, the valve (not shown) between rig storage container 310 and mixer 350 may be adjusted, i.e., opened or closed, based on a mass calculated by mass measuring apparatuses 340.

Referring to FIGS. 1, 2, and 3, in certain embodiments, fluid additives may be stored at a drilling location or well site in large silos and then pneumatically transferred to rig storage containers 210 and 310. In such embodiments, rig storage containers 210 and 310 may be pressurized containers 110, such as those described with respect to mixing system 100. Rig storage containers 210 and 310 may also be smaller in volumetric holding size than pressurized containers 110. As such, rig storage containers 210 and 310 may be used to hold additives that are not used as frequently or in as great of volume as the additives stored in pressurized containers 110. In such an embodiment, a number of separate pressurized containers 110 and rig storage containers 210 and 310 may be connected to allow various blends of additives to be added to a fluid. In such embodiments, any number of batching hoppers 110 and 220 and mixers 150, 250, and 350 may be used. In certain embodiments, the contents of individual containers 110, 210, and 310 may be kept discrete prior to mixing. Thus, mixers 150, 250, and 350 may be configured to receive a flow of contents from any number of containers 110, 210, and 310. Because any number of containers 110, 210, and 310 may be used, the containers 110, 210, and 310 may be disposed at various locations around a well site.

Described below are various design options for containers 110, 210, and 310. Additionally, design options are described for mixers. Those of ordinary skill in the art will appreciate that the design options described below are examples of components that may be used with the embodiments described below and are not intended to limit the scope of the disclosure previously presented.

Pressurized Containers

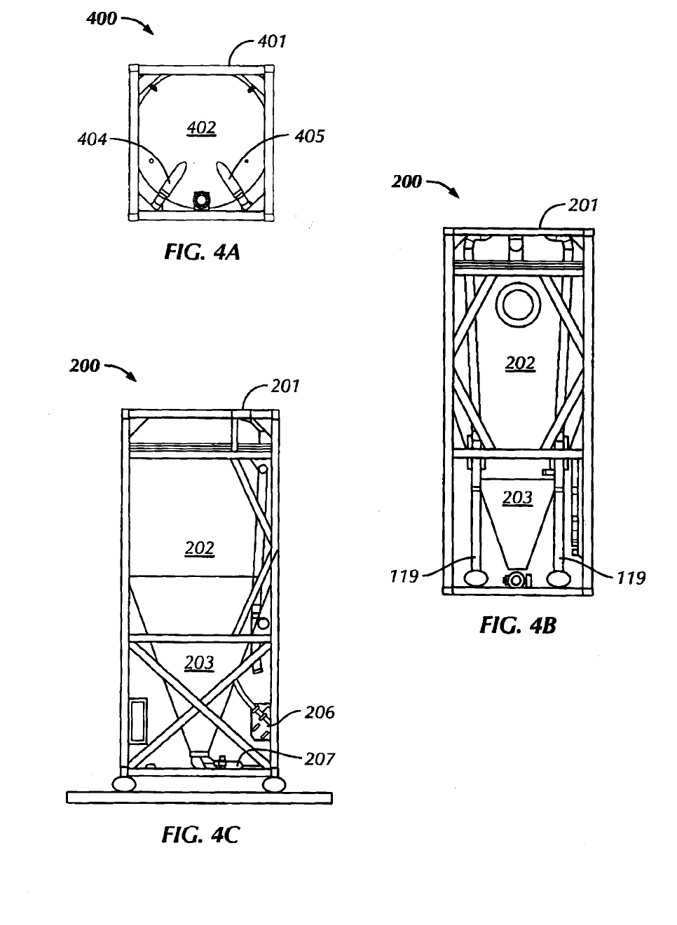

Referring to FIGS. 4A through 4C, pressurized containers according to embodiments of the present disclosure are shown. FIG. 4A is a top view of a pressurized container, while FIGS. 4B and 4C are side views. One type of pressurized container that may be used according to aspects disclosed herein includes an ISO-PUMP™, commercially available from M-I L.L.C., Houston, Tex. In such an embodiment, a pressurized container 400 may be enclosed within a support structure 401. Support structure 401 may hold pressurized container 400 to protect and/or allow the transfer of the container from, for example, a supply boat to a production platform. Generally, pressurized container 400 includes a container 402 having a lower angled section 403 to facilitate the flow of materials between pressurized container 400 and other processing and/or transfer equipment (not shown). A further description of pressurized containers 400 that may be used with embodiments of the present disclosure is discussed in U.S. Pat. No. 7,033,124, assigned to the assignee of the present application, and hereby incorporated by reference herein. Those of ordinary skill in the art will appreciate that alternate geometries of pressurized containers 400, including those with lower sections that are not conical, may be used in certain embodiments of the present disclosure.

Pressurized container 400 also includes a material inlet 404 for receiving material, as well as an air inlet and outlet 405 for injecting air into the container 402 and evacuating air to atmosphere during transference. Certain containers may have a secondary air inlet 406, allowing for the injection of small bursts of air into container 402 to break apart dry materials therein that may become compacted due to settling. In addition to inlets 404, 405, and 406, pressurized container 400 includes an outlet 407 through which dry materials may exit container 402. The outlet 407 may be connected to flexible hosing, thereby allowing pressurized container 400 to transfer materials between pressurized containers 400 or to containers at atmosphere.

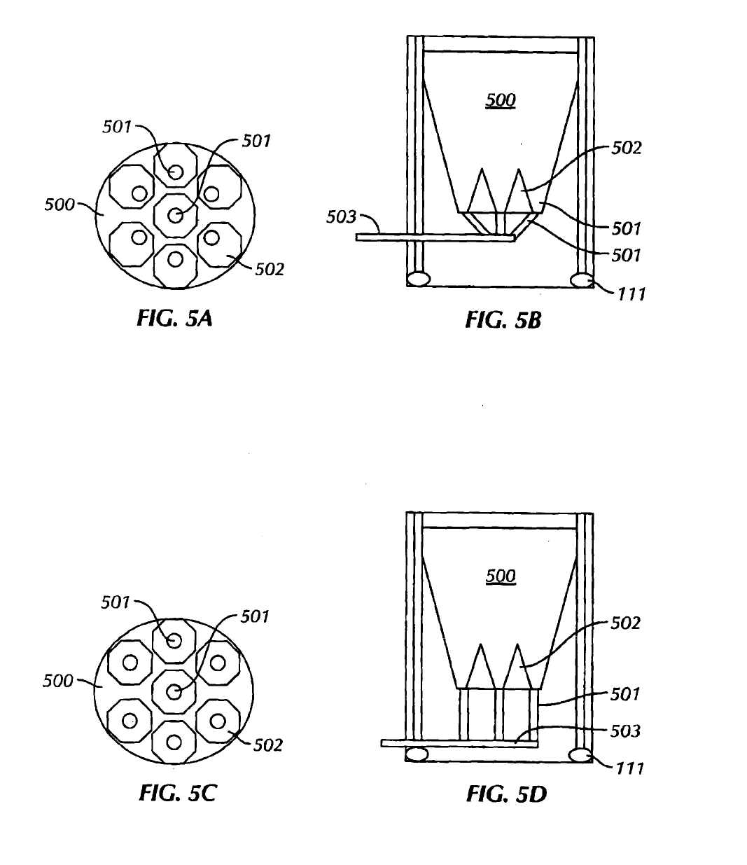

Referring to FIGS. 5A through 5D, a pressurized container 500 according to embodiments of the present disclosure is shown. FIG. 5A and 5C show top views of the pressurized container 500, while FIGS. 5B and 5D show side views of the pressurized container 500.

Referring now specifically to FIG. 5A, a top schematic view of a pressurized container 500 according to an aspect of the present disclosure is shown. In this embodiment, pressurized container 500 has a circular external geometry and a plurality of outlets 501 for discharging material therethrough. Additionally, pressurized container 500 has a plurality of internal baffles 502 for directing a flow of to a specific outlet 501. For example, as materials are transferred into pressurized container 500, the materials may be divided into a plurality of discrete streams, such that a certain volume of material is discharged through each of the plurality of outlets 501. Thus, pressurized container 500 having a plurality of baffles 502, each corresponding to one of outlets 501, may increase the efficiency of discharging materials from pressurized container 500.

During operation, materials transferred into pressurized container 500 may exhibit plastic behavior and begin to coalesce. In traditional transfer containers having a single outlet, the coalesced materials could block the outlet, thereby preventing the flow of materials therethrough. However, the present embodiment is configured such that even if a single outlet 501 becomes blocked by coalesced material, the flow of material out of pressurized container 500 will not be completely inhibited. Moreover, baffles 502 are configured to help prevent materials from coalescing. As the materials flow down through pressurized container 500, the material will contact baffles 502, and divide into discrete streams. Thus, the baffles that divide materials into multiple discrete steams may further prevent the material from coalescing and blocking one or more of outlets 501.

Referring to FIG. 5B, a cross-sectional view of pressurized container 500 from FIG. 5A according to one aspect of the present disclosure is shown. In this aspect, pressurized container 500 is illustrated including a plurality of outlets 501 and a plurality of internal baffles 502 for directing a flow of material through pressurized container 500. In this aspect, each of the outlets 501 are configured to flow into a discharge line 503. Thus, as materials flow through pressurized container 500, they may contact one or more of baffles 502, divide into discrete streams, and then exit through a specific outlet 501 corresponding to one or more of baffles 502. Such an embodiment may allow for a more efficient transfer of material through pressurized container 500.

Referring now to FIG. 5C, a top schematic view of a pressurized container 500 according to one embodiment of the present disclosure is shown. In this embodiment, pressurized container 500 has a circular external geometry and a plurality of outlets 501 for discharging materials therethrough. Additionally, pressurized container 500 has a plurality of internal baffles 522 for directing a flow of material to a specific one of outlets 501. For example, as materials are transferred into pressurized container 500, the material may be divided into a plurality of discrete streams, such that a certain volume of material is discharged through each of the plurality of outlets 501. Pressurized container 500 having a plurality of baffles 502, each corresponding to one of outlets 501, may be useful in discharging materials from pressurized container 500.

Referring to FIG. 5D, a cross-sectional view of pressurized container 500 from FIG. 5C according to one aspect of the present disclosure is shown. In this aspect, pressurized container 500 is illustrated including a plurality of outlets 501 and a plurality of internal baffles 502 for directing a flow of materials through pressurized container 500. In this embodiment, each of the outlets 501 is configured to flow discretely into a discharge line 503. Thus, as materials flow through pressurized container 500, they may contact one or more of baffles 502, divide into discrete streams, and then exit through a specific outlet 501 corresponding to one or more of baffles 502. Such an embodiment may allow for a more efficient transfer of materials through pressurized container 500.

Because outlets 501 do not combine prior to joining with discharge line 503, the blocking of one or more of outlets 501 due to coalesced material may be further reduced. Those of ordinary skill in the art will appreciate that the specific configuration of baffles 502 and outlets 501 may vary without departing from the scope of the present disclosure. For example, in one embodiment, a pressurized container 500 having two outlets 501 and a single baffle 502 may be used, whereas in other embodiments a pressurized container 500 having three or more outlets 501 and baffles 502 may be used. Additionally, the number of baffles 502 and/or discrete stream created within pressurized container 500 may be different from the number of outlets 501. For example, in one aspect, pressurized container 500 may include three baffles 502 corresponding to two outlets 501. In other embodiments, the number of outlets 501 may be greater than the number of baffles 502.

Moreover, those of ordinary skill in the art will appreciate that the geometry of baffles 502 may vary according to the design requirements of a given pressurized container 500. In one aspect, baffles 502 may be configured in a triangular geometry, while in other embodiments, baffles 502 may be substantially cylindrical, conical, frustoconical, pyramidal, polygonal, or of irregular geometry. Furthermore, the arrangement of baffles 502 in pressurized container 500 may also vary. For example, baffles 502 may be arranged concentrically around a center point of the pressurized container 500, or may be arbitrarily disposed within pressurized container 500. Moreover, in certain embodiments, the disposition of baffles 502 may be in a honeycomb arrangement, to further enhance the flow of materials therethrough.

Those of ordinary skill in the art will appreciate that the precise configuration of baffles 502 within pressurized container 500 may vary according to the requirements of a transfer operation. As the geometry of baffles 502 is varied, the geometry of outlets 501 corresponding to baffles 502 may also be varied. For example, as illustrated in FIGS. 5A-5D, outlets 501 have a generally conical geometry. In other embodiments, outlets 501 may have frustoconical, polygonal, cylindrical, or other geometry that allows outlet 501 to correspond to a flow of material in pressurized container 502.

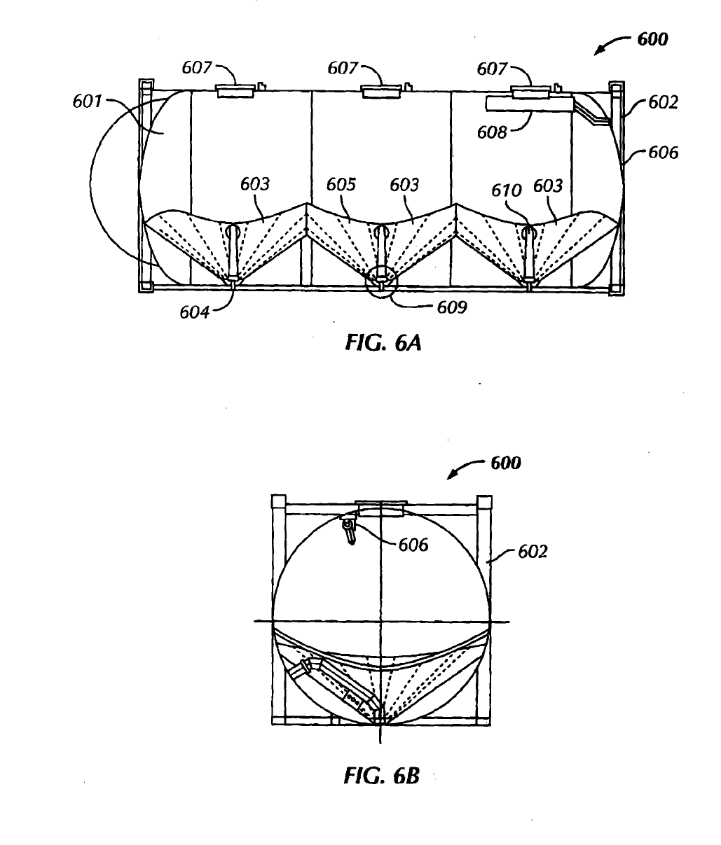

Referring now to FIGS. 6A through 6B, alternate pressurized containers according to aspects of the present disclosure are shown. Specifically, FIG. 6A illustrates a side view of a pressurized container, while FIG. 6B shows an end view of a pressurized container.

In this aspect, pressurized container 600 includes a container 601 disposed within a support structure 602. The container 601 includes a plurality of conical sections 603, which end in a flat apex 604, thereby forming a plurality of exit hopper portions 605. Pressurized container 600 also includes an air inlet 606 configured to receive a flow of air and material inlets 607 configured to receive a flow of materials. During the transference of materials to and/or from pressurized container 600, air is injected into air inlet 606, and passes through a filtering element 608. Filtering element 608 allows for air to be cleaned, thereby removing dust particles and impurities from the airflow prior to contact with the material within the container 601. A valve 609 at apex 604 may then be opened, thereby allowing for a flow of materials from container 601 through outlet 610. Examples of horizontally disposed pressurized containers 600 are described in detail in U.S. Patent Publication No. 2007/0187432 to Brian Snowdon, and is hereby incorporated by reference.

Mixer

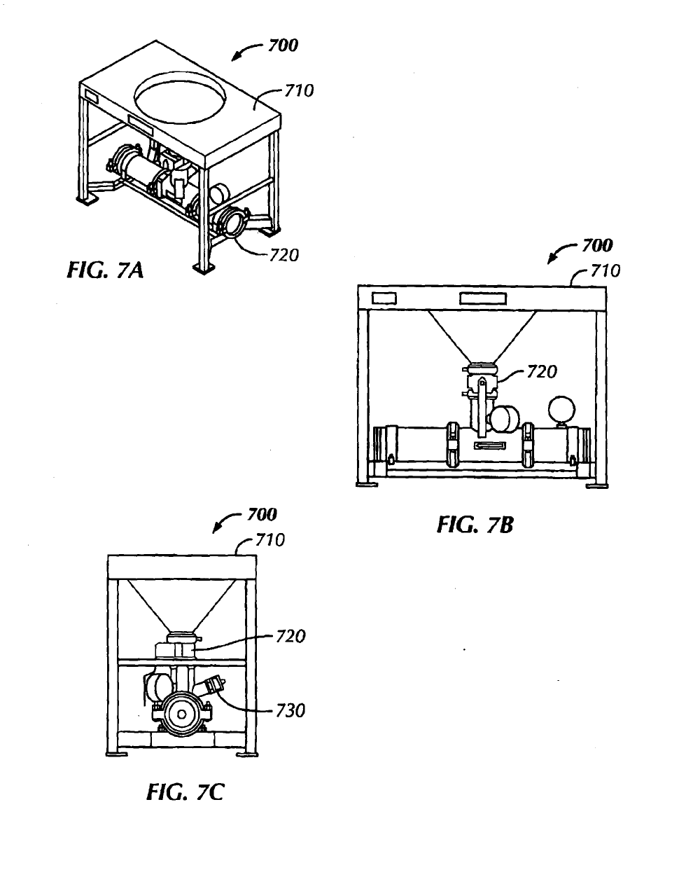

In certain embodiments, a mixer may include a high-speed, rapid-induction, dynamic eductor hopper, such as the HIRIDE Hopper commercially available from M-I Swaco, L.L.C, in Houston, Tex. Referring briefly to FIGS. 7A, 7B, and 8, perspective, side and end views, respectively, of such a mixer 700 according to embodiments of the present disclosure is shown. Mixer 700 includes a table 710 and a dynamic eductor 720. Those of ordinary skill in the art will appreciate that in certain embodiments, mixer 700 does not require use of table 710. As additives flow from the table 710 into the eductor 720, the additives enters a conduit that has a minimum pressure drop nozzle. The flow exits the downstream side of the nozzle at a high velocity thereby creating a zone of relative low pressure, which vacuums the additives into a void space downstream of the nozzle. The additive is then drawn through the opening of a diffuser, where the diffuser promotes turbulence and mixing of the additives with fluids. In certain embodiments, additional fluids or additives may be added to the additives through injection ports 730 on eductor 720.

After the additives exit a first portion of the diffuser, the additives are drawn into a second portion of the diffuser, which again changes the velocity of the flow, creates additional turbulence, and recirculation zones. The flow then enters a second throat of the diffuser and exits through a conduit, which also changes the velocity of the flow and creates additional turbulence and recirculation. As the flow of additives and fluids exits eductor 720, all materials are mixed and effectively entrained in the mixture. Due to the design of the eductor 720, mixer 700 provides a shear source that may provide a shear rate of about 6000 reciprocal seconds at a flow rate of about 800 gallons per minute (gpm). The mixer 107 design also provides a vacuum to draw the additives into eductor 720 and promotes mixing of the additives and fluids as the flow exits mixer 700.

Methods of Mixing Fluids

Referring to FIG. 9, a flowchart of a method for mixing fluids according to embodiments of the present disclosure is shown. Initially, when mixing fluids at a drilling location, contents are transferred 900 from a storage container disposed on a transfer vessel to a rig storage container. The storage container and/or rig storage container may be any type of container discussed above, including pressurized containers. Transfer vessel generally refers to any type of vessel that may be used to transport bulk materials to a well site. In the instance of an onshore rig, the transport vessel may include a truck or train, while in the instance of an offshore rig, the transport vessel may include a supply ship. Once in the rig storage container, the contents may remain for a period of time before use.

After the contents, including fluid additives, are transferred 900 from the storage container to a rig storage container, the contents are transferred 910 from the rig storage container to a batching hopper. As explained above, transferring 910 the contents from rig storage containers to batching hoppers may occur through pneumatic transference. In such a system, rig storage containers may be pressurized, through the use of an air compressor, to positively displace the contents in the rig storage container. The contents may be allowed to flow from the rig storage container to the batching hopper.

After the contents have been transferred 910 from the rig storage containers to the batching hopper, the contents are transferred 920 from the batching hopper into a mixer. Depending on the type of batching hopper and mixer being used, the contents may first flow from the batching hopper into an auger. The auger may then deposit the contents from the auger into the mixer at a controlled rate.

After the contents are transferred 920 to the mixer, the contents are mixed 930 with a flow of fluid from a rig fluid system. In order to produce a mixed fluid that has desired properties, properties of the fluid prior to entering the mixer may be measured. For example, fluid properties may be measured in the active fluid system, in a reservoir pit, or inline, through use of an inline flow meter. Based on the determined fluid properties, a transfer rate of the contents from the batching hopper into the mixer may be adjusted.

In certain embodiments, a mass of contents in the rig storage container may be measured prior to transferring 910 the contents from the rig storage container to the batching hopper. In such an embodiment, the air flow rate for the particular solids contents are determined such that the volume of solids being transferred from rig storage container to the batching hopper may be calculated. Given the air flow rate for particular solids content, the volume of content transferred in a particular time interval may be calculated. The speed of the auger may then be adjusted so that the proper volume of content is added to a base fluid by the mixer.

In some embodiments, mass measuring apparatuses may be connected to the batching hopper in order to determine a mass of content in the batching hopper. The mass may be transmitted to an HMI and used in controlling the speed of the auger, and thus the volume of solids content transferred to the mixer. In embodiments where the HMI receives mass updates from the mass measuring apparatuses, an automated control loop may be used to automatically control the transfer of particular types of solids content into the mixer. For example, because the HMI receives updated data about the mass of solids content in the batching hopper, and may receive data including fluid properties, the HMI may automatically adjust the speed of the auger in order to produce a particular fluid.

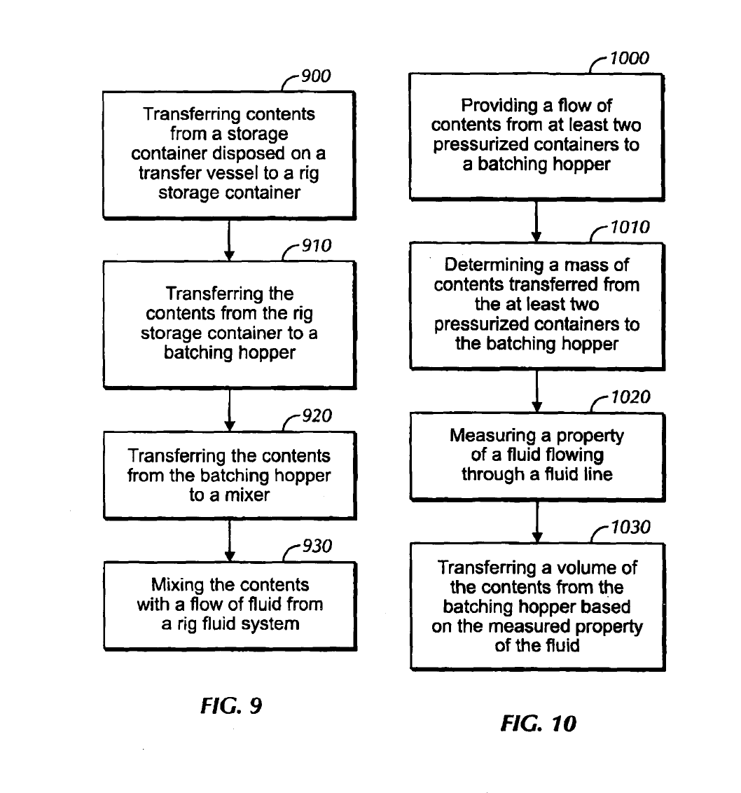

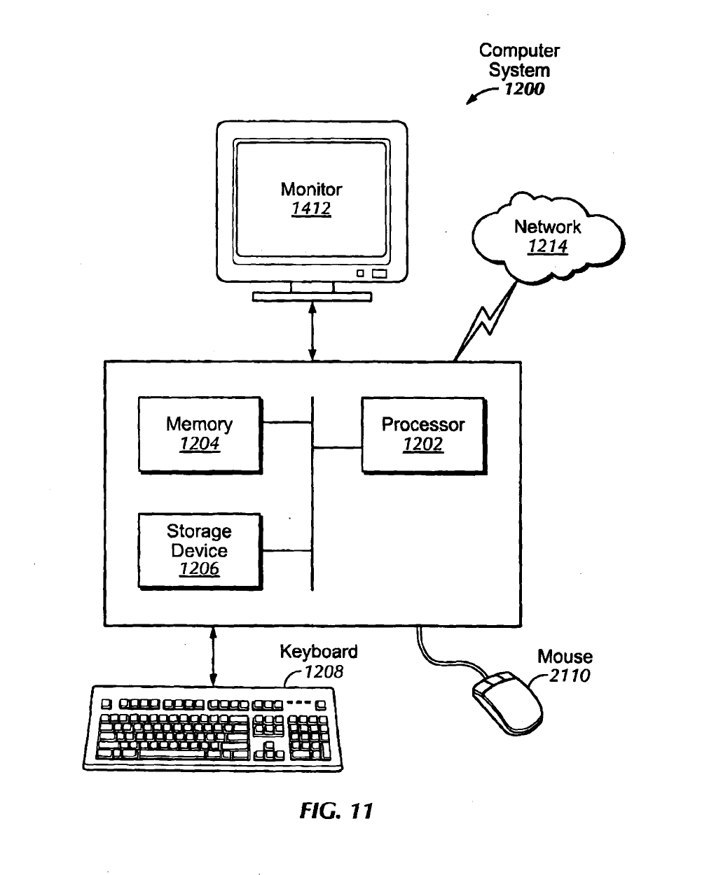

Referring to FIG. 10, a flowchart of a method for mixing fluids according to embodiments of the present disclosure is shown. In this embodiment, a flow of contents is provided 1000 from at least two pressurized containers to a batching hopper. After the flow of contents is transferred 1000, a mass of the transferred contents is determined 1010. The mass may be determined 1010 through use of an HMI receiving mass data from mass measuring apparatuses on either the pressurized containers or the batching hopper.

A property of a fluid flowing through a fluid line is also measured 1020 and transmitted to an HMI. The property of the fluid may be measured through use of an inline sensor, or through the use of sensors in the active drilling system. The HMI, with the fluid property data and the data received from the mass measuring apparatus may then compare data against a desired fluids property to determine how to proceed. After the HMI determines how to proceed, a volume of the contents from the batching hopper is transferred 930 to the mixer based on the measured property of the fluid.

For example, an operator may input into the HMI desired fluid parameters of the fluid flowing through the fluid line. The HMI may then compare the measured property of the fluid flowing through the fluid line by a sensor with the corresponding desired fluid parameter input by the operator and determine the difference between the two. If the HMI determines there is a difference between the measured property and the desired property, the HMI can then send a control signal to the pressurized containers to provide a select amount (i.e., mass or volume) of material from the pressurized containers to a mixer and into the flow line based on the determined difference and the data received from the mass measuring apparatus. Thus, the system and method described herein provides a safe and efficient method of automatically dosing a fluid in a flow line to maintain desired fluid properties of the fluid flowing through the flow line. Such an automated system and method allows for a fluid to be monitored and adjusted without requiring manual handling and loading of bags of materials.

Those of ordinary skill in the art will appreciate that the HMI may also make other determinations based on the data provided. In one embodiment, data from the mass measuring apparatus may be provided to the HMI. Based on the data, the HMI can determine whether sufficient content is in the batching hopper to allow the mixing operation to proceed. If there is not sufficient content in the batching hopper, the HMI can send a control signal to the pressurized containers to send additional content to the batching hoppers. Similarly, the HMI may receive data from the pressurized containers indicating a mass of content in the pressurized containers, so that the HMI may determine how long a mixing operation may occur without running out of contents. In still other embodiments, the HMI may be connected to a rig management system. Thus, the HMI can provide data regarding contents inventory and status of the mixing operation.

Embodiments of the present disclosure may be implemented on virtually any type of computer regardless of the platform being used. Specifically, an HMI may have a computer implemented interface. For example, as shown in FIG. 11, a computer system 1200 includes one or more processor(s) 1202, associated memory 1204 (e.g., random access memory (RAM), cache memory, flash memory, etc.), a storage device 1206 (e.g., a hard disk, an optical drive such as a compact disk drive or digital video disk (DVD) drive, a flash memory stick, etc.), and numerous other elements and functionalities typical of today's computers (not shown). The computer 1200 may also include input means, such as a keyboard 1208, a mouse 1210, or a microphone (not shown).

Further, the computer 1200 may include output means, such as a monitor 1212 (e.g., a liquid crystal display (LCD), a plasma display, or cathode ray tube (CRT) monitor). The computer system 1200 may be connected to a network 1214 (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system 1200 includes at least the minimal processing, input, and/or output means necessary to practice embodiments of the invention.

Further, those skilled in the art will appreciate that one or more elements of the aforementioned computer system 1200 may be located at a remote location and connected to the other elements over a network. Further, embodiments of the invention may be implemented on a distributed system having a plurality of nodes, where each portion of the invention (e.g., data repository, signature generator, signature analyzer, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Advantageously, embodiments of the present disclosure may provide for more efficient and safer methods and systems for mixing fluids. More specifically, embodiments of the present disclosure may provide more efficient and safer methods and systems for mixing drilling fluids at drilling well sites. More specifically, systems and methods disclosed herein may provide an automated fluid management system, for example a mud management system, that provides automatic dosing of a fluid in a flow line to maintain desired fluid properties of the fluid flowing through the flow line.

Although only a few example embodiments have been described in detail above, those skilled in the art will readily appreciate that many modifications are possible in the example embodiments without materially departing from the scope of the present disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A system for mixing fluids, the system comprising:
at least two pressurized containers;
a hatching hopper in fluid communication with at least one of the at least two pressurized containers;
a mixer in fluid communication with the hatching hopper; and
a fluid line in fluid communication with the mixer.

2. The system of claim 1, further comprising at least a second hatching hopper, wherein the hatching hopper is in fluid communication with one of the at least two pressurized containers and wherein the second hatching hopper is in fluid communication with a second of the at least two pressurized containers.

3. The system of claim 1, wherein the hatching hopper comprises an auger disposed at a distal end of the hatching hopper.

4. The system of claim 1, wherein the hatching hopper is operatively connected to a mass measuring apparatus.

5. The system of claim 4, wherein the mass measuring apparatus is configured to calculate a mass of contents in the batching hopper.

6. The system of claim 4, wherein the mass measuring apparatus is operatively connected to a human machine interface.

7. The system of claim 6, wherein a flow of contents from the hatching hopper is controlled by the human machine interface.

8. A method of mixing fluids, the method comprising:
providing a flow of contents from at least two pressurized containers to a batching hopper;
determining a mass of contents transferred from the at least two pressurized containers to the hatching hopper;
measuring a property of a fluid flowing through a fluid line, wherein the fluid line is in fluid communication with the hatching hopper; and
transferring a volume of the contents from the hatching hopper to a mixer, wherein the volume transferred is adjusted based on the measured property of the fluid.

9. The method of claim 8, further comprising determining an air flow rate for the contents.

10. The method of claim 8, wherein the transferring is controlled by adjusting a speed of an auger disposed between the batching hopper and the mixer.

11. The method of claim 8, wherein the providing further comprises providing at least two contents from the at least two pressurized containers to the batching hopper, wherein the at least two contents are provided to the hatching hopper sequentially or simultaneously.

12. A. system for mixing fluids, the system comprising:
a first pressurized container disposed at a first location at a drilling site;
a second pressurized container disposed at a second location at the drilling site;
a batching hopper in fluid communication with at least one of the first and second pressurized containers;
an auger disposed at a distal end of the batching hopper and in fluid communication with the hatching hopper; and
a mixer in fluid communication with the auger.

13. The system of claim 12, further comprising a second batching hopper, wherein the hatching hopper is in fluid communication with the first pressurized container and the second batching hopper is in fluid communication with the second pressurized container.

14. The system of claim 12, further comprising at least one air compressor in fluid communication with at least one of the first and second pressurized containers.

15. An automated method of mixing fluids, the method comprising:
measuring a property of a fluid in a rig fluid system;
transferring contents from a rig storage container to a batching, hopper;
transferring the contents from the batching hopper to a mixer; determining an amount of contents to add to a flow of the fluid in the rig fluid system based on the measured property; and
mixing the determined amount of contents in the mixer with the flow of fluid from the rig fluid system.

16. The method of claim 15, wherein the rig storage container comprises a pressurized container.

17. The method of claim 15, further comprising Comparing a desired fluid property with the measured property of the fluid in the rig fluid system

18. The method of claim 15, further comprising automatically adjusting a transfer rate of the contents from the hatching hopper to the mixer based on the determined amount of contents to add.

19. The method of claim 15, further comprising:
measuring a mass of contents in the rig storage container; and
automatically adjusting a transfer rate of the contents from at least one of the rig storage container and the batching hopper based on the measured mass of contents in the rig storage container and the determined amount of contents to add.

20. The method of claim 15, furthering comprising transferring contents from a storage container disposed on a transfer vessel to the rig storage container.
